(19) United States
(12) Patent Application Publication
(10) Pub. No.: US 2018/0347159 A1
(43) Pub. Date: Dec. 6, 2018

(54) SKIN EQUIPPED WITH INTELLIGENT CONTROL CENTER FOR BATHROOM

(71) Applicant: Dong Guan Song Wei Electric Technology Co., Ltd., Dongguan City (CN)

(72) Inventor: Weilin Lu, Dongguan City (CN)

(21) Appl. No.: 15/613,100

(22) Filed: Jun. 2, 2017

(51) Int. Cl. E03C 1/05; A47K 17/00; E03D 5/10; E03D 9/00; G05B 15/02

(52) U.S. Cl. CPC E03C 1/057; A47K 17/00; G05B 15/02; E03D 9/002; E03D 5/105

(57) ABSTRACT

A sink equipped with an intelligent control center for bathroom includes a main body, a mirror and a concealed bathroom central controller. The mirror is arranged on the main body. The concealed bathroom central controller is arranged at a rear side of the mirror. In addition, the mirror includes a mirror defogging system and a human detection system. The concealed bathroom central controller comprises a signal processing module, a touch control display device, a WIFI transmission system, a battery power supply system and a battery charging system.

### TECHNICAL FIELD OF THE INVENTION

The present invention is related to the technical field of bathroom, in particular, to sink equipped with an intelligent control center for bathroom.

### DESCRIPTION OF THE PRIOR ART

Currently, with the improvement of the living quality of people, bathroom has become an important part of the people's daily lives, and sink is an essential element of bathroom. In the currently existing art, sinks are mostly used to provide the functions of mirror and wash to users such that sinks offer no further convenient functions to users. Consequently, there is a need for an improvement to the currently existing bathroom sinks.

### SUMMARY OF THE INVENTION

In view of the aforementioned drawback of the known art, an objective of the present invention is to provide a sink equipped with an intelligent control center for bathroom such that it is of the characteristics of diverse functions and facilitated uses.

To achieve the aforementioned objective, the present invention provides a sink equipped with an intelligent control center for bathroom, comprising: a main body; a mirror arranged on the main body; a concealed bathroom central controller arranged at a rear side of the mirror; and wherein the mirror includes a mirror defogging system and a human detection system; the concealed bathroom central controller comprises a signal processing module, a touch control display device, a WIFI transmission system, a battery power supply system and a battery charging system; the mirror defogging system, the human detection system, the touch control display device, the WIFI transmission system, the battery power supply system and the battery charging system are call connected to the signal processing module.

According to a preferred embodiment of the sink equipped with an intelligent control center for bathroom, the mirror is a coated and tempered glass.

According to a preferred embodiment of the sink equipped with an intelligent control center for bathroom, the mirror defogging system is arranged at the rear side of the mirror and the human detection sensor is arranged at a front side of the mirror.

According to a preferred embodiment of the sink equipped with an intelligent control center for bathroom, the signal processing module further comprises a lighting control system, a bathroom heating control system and a bathroom exhaust control system connected thereto.

According to a preferred embodiment of the sink equipped with an intelligent control center for bathroom, the signal processing module further comprises a sink water temperature control system and an infrared sensor water supply system connected thereto.

According to a preferred embodiment of the sink equipped with an intelligent control center for bathroom, the signal processing module further comprises a bathtub water level control system and a bathtub water temperature control system connected thereto.

According to a preferred embodiment of the sink equipped with an intelligent control center for bathroom, the signal processing module further comprises a human detection toilet cleaning system connected thereto.

The present invention is clearly of merits and advantageous effects over the known art. To be more specific, from the aforementioned technical solution, it can be understood that:

With the concealed bathroom central controller arranged at the rear side of the mirror, the concealed bathroom central controller can be used to perform intelligent controls on all systems in the bathroom. In addition, the mirror defogging system can be cooperatively arranged with the bathroom central controller in order to perform defogging of the mirror and to maintain clearness of the mirror. The present invention integrates the functions of cleaning, mirror and controls such that it is of diverse functions and is able to provide great convenience to users.

### BRIEF DESCRIPTION OF DRAWING

FIG. 1 is a front view of a preferred embodiment of the present invention;

FIG. 2 is a partial side view of a preferred embodiment of the present invention; and

FIG. 3 is a block diagram showing the control principle of a preferred embodiment of the present invention.

### DETAILED DESCRIPTION OF THE INVENTION

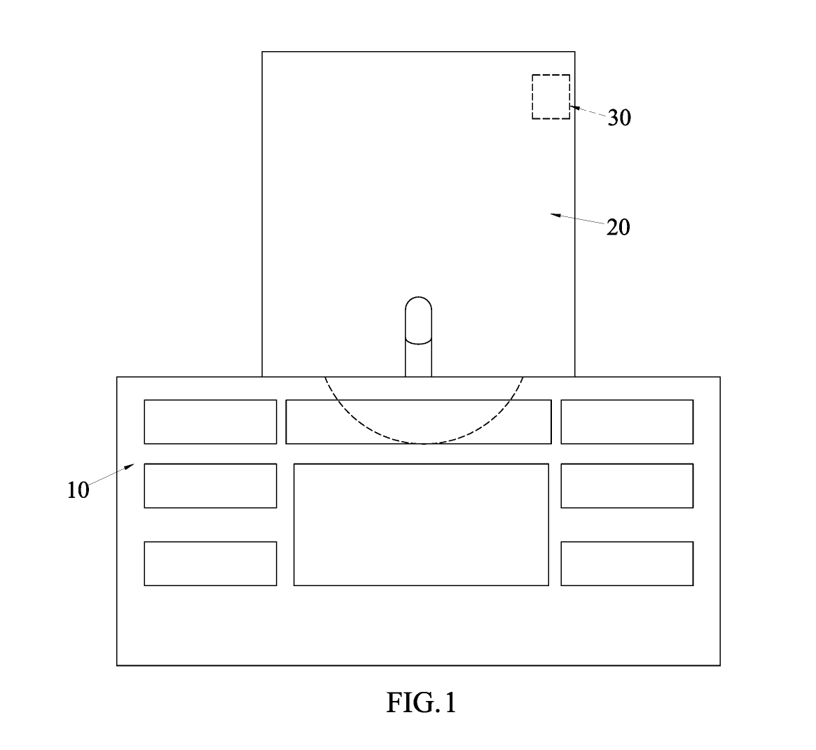

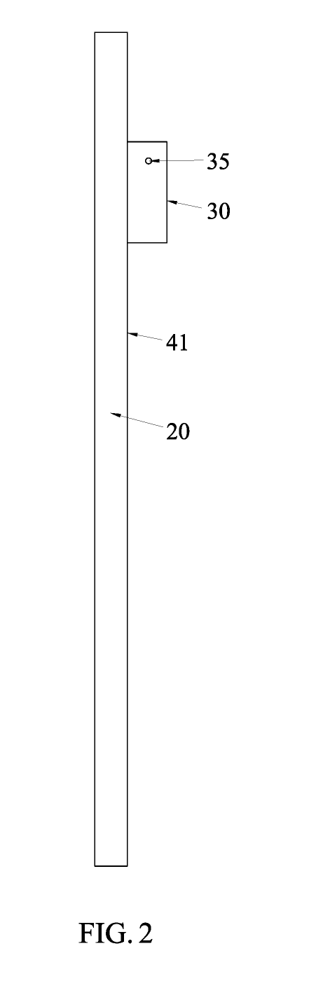

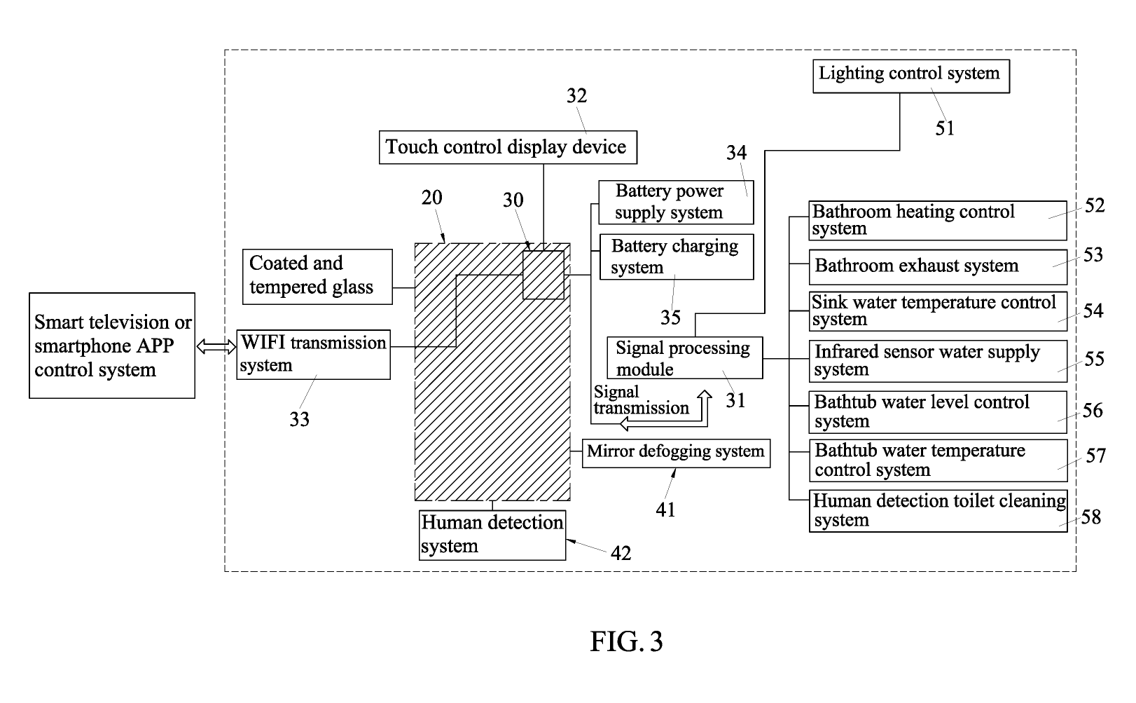

As shown in FIG. 1 to FIG. 4, according to a preferred embodiment of the present invention, a sink equipped with an intelligent control center for bathroom comprises a main body 10, a mirror 20 and a concealed bathroom central controller 30.

The mirror 20 is arranged on the main body 10, and in this embodiment, the mirror 20 is a coated and tempered glass.

The concealed bathroom central controller 30 is arranged at a rear side of the mirror 20, and wherein the mirror 20 includes a mirror defogging system 41 and a human detection system 42. The concealed bathroom central controller 30 comprises a signal processing module 31, a touch control display device 32, a WIFI transmission system, 33 a battery power supply system 34 and a battery charging system 35. The mirror defogging system 41, the human detection system 42, the touch control display device, 32 the WIFI transmission system 33, the battery power supply system 34 and the battery charging system 35 are call connected to the signal processing module 31. In this embodiment, the mirror defogging system 41 is arranged at the rear side of the mirror 20 and the human detection sensor 40 is arranged at a front side of the mirror 20.

In addition, the signal processing module 31 further comprises a lighting control system 51, a bathroom heating control system 52 and a bathroom exhaust control system 53, a sink water temperature control system 54 and an infrared sensor water supply system 55, a bathtub water level control system 56, a bathtub water temperature control system 57 and a human detection toilet cleaning system 58 connected thereto.

The operating principle of the present embodiment is as follows:

During the use, the WIFI transmission system 33 can be wirelessly connected to a smart television or smartphone APP control system in communication in order to perform controls on the concealed bathroom central controller 30 such that the concealed bathroom central controller 30 is able to further control each system for achieving the controls of colorful lighting, heating and exhaust of air etc. In addition, when a user enters the bathroom and after the human detection system 42 detects the user, each system is then activated such that the lighting control system 51 is able to control the illuminating lamps, the bathroom heating control system is able to control the heating device, the bathroom exhaust system 53 is able to control the exhaust device, the sink water temperature control system 54 is able to control the sink water temperature, the infrared sensor water supply system 55 is able to control the water supply of the sink, the bathtub water level control system 56 is able to control the bathtub water level, the bathtub water temperature control system 57 is able to control the water temperature of the bathtub and the human detection toilet cleaning system 58 is able to control the toilet cleaning Consequently, the ambient temperature of the bathroom can be pre-set for controls or can be controlled in real time, and the infrared detection water supply system 55 installed on the sink can cooperate with the sink water temperature control system 54 in order to achieve the advantage of great saving amount of water consumption. The human detection toilet cleaning system 58 can cooperate with the toilet reservoir water level control system in order to perform repetitive flushes of the toilet and to further increase the saving of the water consumption of the toilet.

The key features of the design of the present invention include but not limited to: with the concealed bathroom central controller arranged at the rear side of the mirror, the concealed bathroom central controller can be used to perform intelligent controls on all systems in the bathroom. In addition, the mirror defogging system can be cooperatively arranged with the bathroom central controller in order to perform defogging of the mirror and to maintain clearness of the mirror. The present invention integrates the functions of cleaning, mirror and controls such that it is of diverse functions and is able to provide great convenience to users.

I claim:

1. A sink equipped with an intelligent control center for bathroom, comprising:
a main body;
a mirror arranged on the main body;
a concealed bathroom central controller arranged at a rear side of the mirror; and
wherein the mirror includes a mirror defogging system and a human detection system; the concealed bathroom central controller comprises a signal processing module, a touch control display device, a WIFI transmission system, a battery power supply system and a battery charging system; the mirror defogging system, the human detection system, the touch control display device, the WIFI transmission system, the battery power supply system and the battery charging system are call connected to the signal processing module.

2. The sink equipped with an intelligent control center for bathroom according to claim 1, wherein the mirror is a coated and tempered glass.

3. The sink equipped with an intelligent control center for bathroom according to claim 1, wherein the mirror defogging system is arranged at the rear side of the mirror and the human detection sensor is arranged at a front side of the mirror.

4. The sink equipped with an intelligent control center for bathroom according to claim 1, wherein the signal processing module further comprises a lighting control system, a bathroom heating control system and a bathroom exhaust control system connected thereto.

5. The sink equipped with an intelligent control center for bathroom according to claim 1, wherein the signal processing module further comprises a sink water temperature control system and an infrared sensor water supply system connected thereto.

6. The sink equipped with an intelligent control center for bathroom according to claim 1, wherein the signal processing module further comprises a bathtub water level control system and a bathtub water temperature control system connected thereto.

7. The sink equipped with an intelligent control center for bathroom according to claim 1, wherein the signal processing module further comprises a human detection toilet cleaning system connected thereto.
